(19) United States
(12) Patent Application Publication
(10) Pub. No.: US 2008/0208437 A1
(43) Pub. Date: Aug. 28, 2008

(54) Fuel-Injector For Internal-Combustion Engine, Methods of Controlling Fuel-Injector, Electronic Control Unit for Fuel-Injector, and Fuel Injection System for Direct Fuel-Injection Engine

(75) Inventors: Hiroyuki NATSUI, Hitachi (JP); Kunihiko Suzuki, Hitachinaka (JP); Kenji Tuchita, Hitachiohta (JP); Sumie Tuchita, Hitachiohta (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/019,169

(22) Filed: Jan. 24, 2008

(30) Foreign Application Priority Data
Feb. 28, 2007 (JP) 2007-048375

(51) Int. Cl. F02D 41/04; F02M 51/06

(52) U.S. Cl. 701/104; 239/585.1; 123/476

(57) ABSTRACT

There was a problem that various fuel spray shapes cannot be obtained according to operating conditions of a direct injection engine. There is provided a giant magnetostrictive element type injector which controls the change rate (rising slope) or peak value of a supply current applied to a solenoid for magnetic field generation which displaces a giant magnetostrictive element according to requests of an engine. The steeper the rising slope of the supply current to the solenoid, the higher becomes a lifting speed of a plunger, the higher becomes the initial speed of a fuel spray, and the longer the penetration can be. The gentler the rising slope thereof, the lower becomes the lifting speed of the plunger, the lower becomes the initial speed of the fuel spray, and the shorter the penetration can be. Further, the larger the peak value of the supply current, the larger the lift amount of the plunger can be and the larger becomes the fuel flow rate, allowing an increase in fuel spray density (resulting in a fuel spray that is not easily crushed). The smaller the peak value of the supply current, the smaller becomes the fuel flow rate, allowing a decrease in fuel spray density (resulting in a fuel spray that is easily crushed).

### BACKGROUND OF THE INVENTION

1. Field of the Invention

The present invention relates to a fuel-injector for an internal-combustion engine and methods of controlling the fuel-injector, and more particularly to a fuel injection system for a direct fuel-injection engine (also referred to as direct injection engine) which supplies fuel directly into the combustion chamber by use of a fuel-injector (also referred to as injector). The present invention also relates to a control circuit unit for the fuel injection system.

2. Description of the Related Art

With a conventional technique disclosed in JP-A-2000-170629, a voltage applied to a piezoelectric element is controlled so as to change the stroke of an injector valve. Further, swirl generation mechanisms having fuel passages corresponding to each stroke are provided so that different fuel spray shapes are obtained with different swirl mechanisms.

### SUMMARY OF THE INVENTION

With the above-mentioned conventional technique, a plurality of swirl mechanisms are required in an upstream fuel passage of a sheet section. The problem with this is that the fuel spray shape varies for each injector because of processing error or assembly error of the swirl mechanisms, and this technique is thus not suitable for commercial production.

An object of the present invention is to provide an injector that can change the fuel spray shape according to engine operating conditions and methods for controlling the injector, i.e., an injector having a small number of parts and methods of controlling the injector with little variation in fuel spray shape.

The above-mentioned object of the present invention is attained by an injector of an internal-combustion engine, comprising: at least one fuel injection hole; a sheet surface located on an upstream side of the fuel injection hole; a valve which controls opening and closing of a fuel passage leading to the fuel injection hole by the valve touching and separating from the sheet surface; and an electromagnetic drive unit which operates the valve; wherein the valve is maintained to any desired opening position between a fully-opened position and a fully-closed position at which the valve comes in contact with the sheet surface depending on the magnitude of the power supplied to the electromagnetic drive unit.

Specifically, the above-mentioned object is attained by controlling the time period of power distribution to the electromagnetic drive unit or an electromagnetic solenoid forming the electromagnetic drive unit to control the fuel injection quantity; and at the same time controlling at least either one of the rising slope and the peak value of the power to control at least either one of the penetration, the fuel spray angle, and the fuel spray density of injected fuel.

Further, preferably, the above-mentioned object is attained by the electromagnetic drive unit comprising: an electromagnetic solenoid; a magnetostrictive element whose amount of expansion/contraction varies with electromagnetic force generated by the electromagnetic solenoid; and a displacement transmission mechanism that transmits the displacement of expansion/contraction of the magnetostrictive element to the valve.

In accordance with the present invention having the above-mentioned configuration, it is possible to provide an injector suitable for mass production having a small number of processed parts affecting the fuel spray shape and accordingly little variation in fuel spray shape among injectors. Further, since there is little variation, the variation can be absorbed through control.

### BRIEF DESCRIPTION OF THE DRAWINGS

FIG. 1 is a schematic diagram of a direct injection engine.

FIG. 2 is a schematic diagram of a giant magnetostrictive injector.

FIG. 3 is a diagram showing a supply current having a steep rising slope and a corresponding fuel spray shape.

FIG. 4 is a diagram showing supply currents having a gentle rising slope and corresponding fuel spray shapes.

FIG. 5 is a diagram showing a supply current having a large peak value and corresponding fuel spray shapes.

FIG. 6 is a diagram showing a supply current having a small peak value and corresponding fuel spray shapes.

FIG. 7 shows the relation between amounts of plunger lift and fuel flow rates.

FIG. 8 is a diagram explaining injection methods in each of operation regions.

FIG. 9 is a diagram showing a supply current waveform in operation region (i).

FIG. 10 is a diagram showing supply current waveforms in operation region (ii).

FIG. 11 is a diagram showing supply current waveforms in operation region (iii).

FIG. 12 is a diagram showing a supply current waveform in operation region (iv).

FIG. 13 is a diagram showing supply current waveforms in operation region (v).

FIG. 14 is a diagram showing an engine control unit.

FIG. 15 is diagram showing an exemplary method of determining a supply current waveform.

FIG. 16 is a schematic diagram of a center injection engine.

FIG. 17 is a diagram explaining reduction of fuel adhesion by the center injection engine.

FIG. 18 is a diagram showing a fuel spray at the time of stratified combustion with the center injection engine.

### DETAILED DESCRIPTION OF THE PREFERRED EMBODIMENTS

The present invention will be explained in detail below with reference to embodiments shown in the accompanying drawings.

The present embodiment is configured based on a fundamental principle shown below.

A change rate (rising slope) or peak value of a supply current applied to an injector using a giant magnetostrictive element as an actuator and a solenoid for magnetic field generation which displaces the giant magnetostrictive element are controlled according to requests of an engine. The steeper the rising slope of the supply current to the solenoid, the higher becomes a lifting speed of a plunger and the initial speed of a fuel spray, and the longer the penetration can be. The gentler the rising slope thereof, the lower becomes the lifting speed of the plunger and the initial speed of the fuel spray, and the shorter the penetration can be. Further, the larger the peak value of the supply current to the solenoid, the larger the lift amount of the plunger can be and the larger becomes the fuel flow rate, allowing an increase in fuel spray density (resulting in a fuel spray that is not easily crushed). The smaller the peak value of the supply current, the smaller becomes the fuel flow rate, allowing a decrease in fuel spray density (resulting in a fuel spray that is easily crushed).

Since the shape of a fuel spray injected can be controlled by changing the rising slope and the peak value of the current waveform which drives the giant magnetostrictive injector, it is possible to inject a fuel spray according to engine operating conditions. This makes it possible to realize various fuel spray shapes according to operation conditions of a direct injection engine, thus improving the exhaust gas performance and fuel efficiency.

### First Embodiment

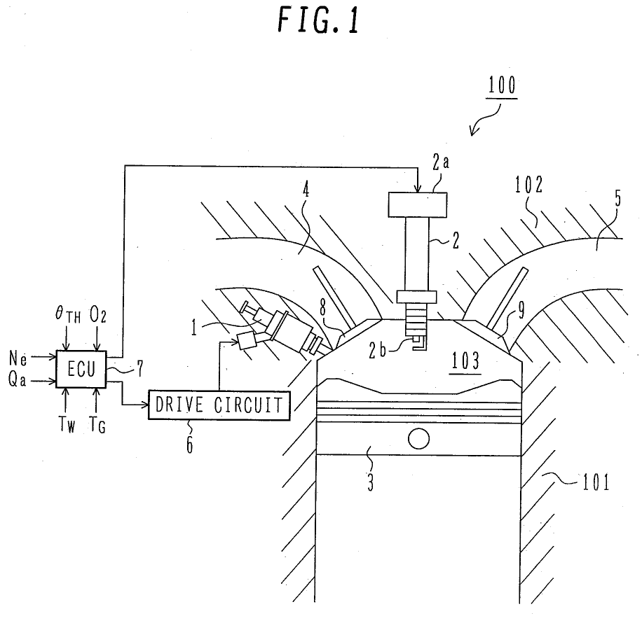

An example of a direct injection engine according to the present invention is shown in FIG. 1.

An engine 100 comprises a cylinder 101 and a cylinder head 102. An ignition plug 2b is provided at the center of the cylinder head 102 in such a way to protrude into a combustion chamber 103.

A suction passage 4 and an exhaust passage 5 are formed in the cylinder head 102 such that an ignition coil 2 is sandwiched therebetween, each passage being connected to the combustion chamber 103 in the cylinder 101.

A suction valve 8 is provided at a connecting section between the suction passage 4 and the cylinder 103.

An exhaust valve 9 is provided at a connecting section between the exhaust passage 5 and the cylinder 103.

In the cylinder, a piston 3 is arranged so as to perform reciprocating motion with which the volume of the combustion chamber 103 changes.

The fuel injector (hereinafter referred to as injector) 1 is provided in the middle of two suction valves 8 (one is not shown) on the side of the suction passage 4 of the cylinder to inject fuel directly into the combustion chamber 103 in the cylinder 101.

An independent ignition type ignition coil 2 integrated with an igniter 2a is provided in an attachment hole of the ignition plug 2b.

An injector 1 is controlled through a drive circuit 6 based on signals of an engine control unit (ECU) 7.

The ignition coil 2 is controlled through the igniter 2a based on signals of the engine control unit (ECU) 7.

Input into the engine control unit (ECU) 7 are an output signal Qa of an intake air quantity sensor (not shown) provided in the suction passage 4, a signal Ne of an engine rotational speed sensor (not shown) provided in the vicinity of the revolving shaft of the engine, a signal Tw of an engine cooling water temperature sensor (not shown) provided in the cylinder section of the engine, a signal O₂ of an air-fuel ratio sensor (O₂ sensor, not shown) provided in the exhaust passage 5, and a signal θTH of a throttle opening sensor (not shown) for detecting the opening of a throttle device provided in the suction pipe.

Control signals of the injector 1 and the ignition coil 2 are obtained based on these input signals.

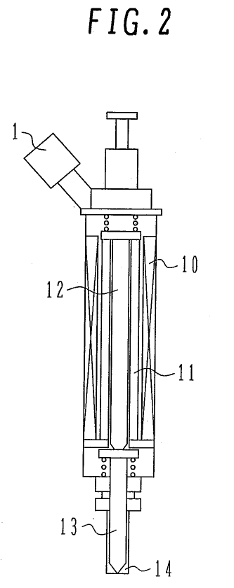

As shown in FIG. 2, the injector 1 is composed of a solenoid 10 for magnetic field generation and a giant magnetostrictive element 11 and subjected to open/close control by control signals from the ECU 7.

FIG. 2 is an exemplary configuration of an injector using a giant magnetostrictive element.

The injector is composed of the solenoid 10 for magnetic field generation, the giant magnetostrictive element 11, a plunger 12, a valve opening/closing plunger 13, and an orifice plate 14.

When a fuel injection signal from the ECU 7 is inputted to the injector drive circuit 6 and a drive current is inputted from the injector drive circuit to the injector 1 to be mentioned later in detail, a magnetic field is generated by the solenoid 10 shown in FIG. 2, the giant magnetostrictive element 11 is displaced (elongated), the plunger 12 formed on the upper side of the giant magnetostrictive element 11 is pulled up, the valve opening/closing plunger 13 formed on the lower side of the plunger 12 is also pulled up to open the valve, and high-pressure fuel pressurized by a high-pressure pump (not shown) is injected into the combustion chamber.

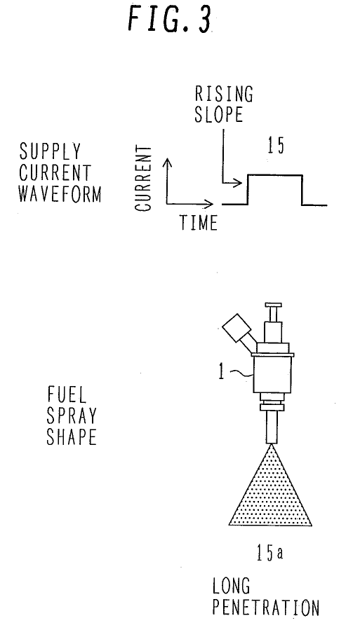

FIGS. 3 to 6 are examples showing the relation between current waveforms inputted into the injector 1 and shapes of injected fuel sprays. Referring to FIG. 3, reference numeral 15 denotes a current waveform with the horizontal axis assigned time and the vertical axis currents, and reference numeral 15a denotes the shape of a fuel spray injected from the injector 1 when the above-mentioned current waveform is inputted.

Since the giant magnetostrictive element 11 rapidly responds to a current change applied to the solenoid 10 for magnetic field generation, it is possible to precisely control the by the lift behavior of the valve opening/closing plunger 13 by use of the current applied to the solenoid 10.

That is, change characteristics of the current flowing in the solenoid almost correspond to response characteristics of the plunger. Therefore it can be said that the response speed of the plunger is dependent on the rising speed of the current.

Further, the stroke of the plunger almost corresponds to the magnitude of the current applied to the solenoid, i.e., the larger the current, the larger becomes the stroke. The smaller the current, the smaller becomes the maintained stroke position.

Therefore, if the magnitude of the current applied to the solenoid is linearly changed, it is possible to linearly change cross-sectional areas A1 and A2 of fuel passages between a valve V and a sheet surface S provided at an end of the plunger 13.

If a current waveform 15 having a steep rising slope as shown in FIG. 3 is applied to the solenoid 10 as a current waveform inputted from the drive circuit 6, the valve opening speed of the valve opening/closing plunger 13 increases. Accordingly, the rising rate of the fuel flowing in between the valve opening/closing plunger 13 and the valve seat 14 increases. Further, the initial speed of fuel spray injected from the injector 1 increases, making it possible to form a fuel spray 15a having a long penetration as shown in FIG. 3.

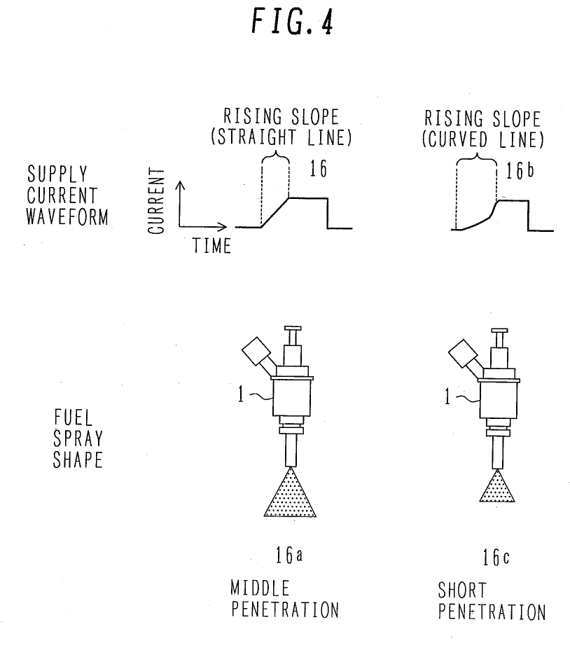

On the other hand, if a current waveform 16 having a gentle rising slope of FIG. 4 is applied to the solenoid 10, the lifting speed of the valve opening/closing plunger 13 decreases. Accordingly, the rising rate of the fuel flowing in between the plunger 13 and the valve seat 14 decreases, resulting in a reduced initial speed of the fuel spray injected from the injector 1. Therefore, a fuel spray 16a having a small penetration can be formed. Further, as shown in 16b of FIG. 4, the penetration can further be shortened by making the rising slope of the supply current a curve line.

With the above-mentioned methods, the penetration can be controlled by the rising slopes of the supply current applied to the solenoid 10.

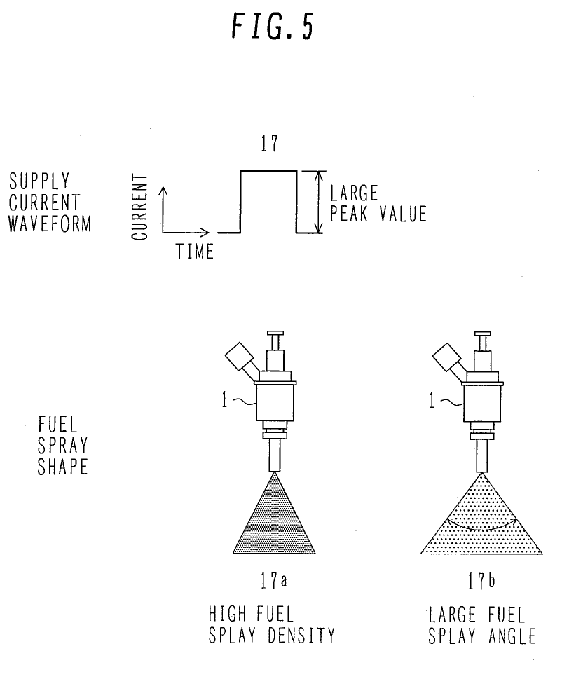

When a supply current 17 having a large peak value is applied to the solenoid 10 as shown in FIG. 5, the lift amount of the valve opening/closing plunger 13 also increases. Therefore, as shown in FIG. 7, the flow rate of the fuel flowing in between the valve opening/closing plunger 13 and the valve seat 14 increases. Accordingly the density of the fuel spray injected from the injector 1 increases, allowing an increase in intensity of the fuel spray 17a (resulting in a fuel spray that is not easily crushed). Further, with an injector that performs swirling injection, if the supply current 17 is given, the fuel flow rate increases. Accordingly, the swirl force increases, making it possible to form a fuel spray 17b having a large fuel spray spread (large fuel spray angle).

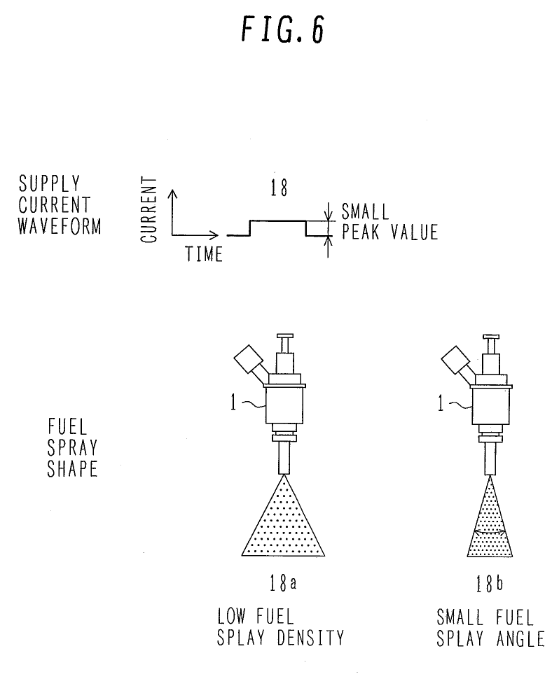

On the other hand, if a supply current 18 having a small peak value is applied to the solenoid 10 as shown in FIG. 6, the flow rate of the fuel flowing in between the valve opening/closing plunger 13 and the valve seat 14 decreases as shown in FIG. 7. Accordingly, the density of the fuel spray injected from the injector 1 decreases, thus decreasing the intensity of the fuel spray 18a (resulting in a fuel spray that is easily crushed). In this case, with the injector which performs swirling injection, if the supply current 18 having a small peak value is inputted, the swirl force applied to the fuel spray decreases because of a small fuel flow rate, thus forming a fuel spray 18b having a small fuel spray spread (small fuel spray angle).

With the above-mentioned methods, it is possible to control the density (resistance to being crushed) or the fuel spray angle of the fuel spray by the peak values of the supply current applied to the solenoid 10.

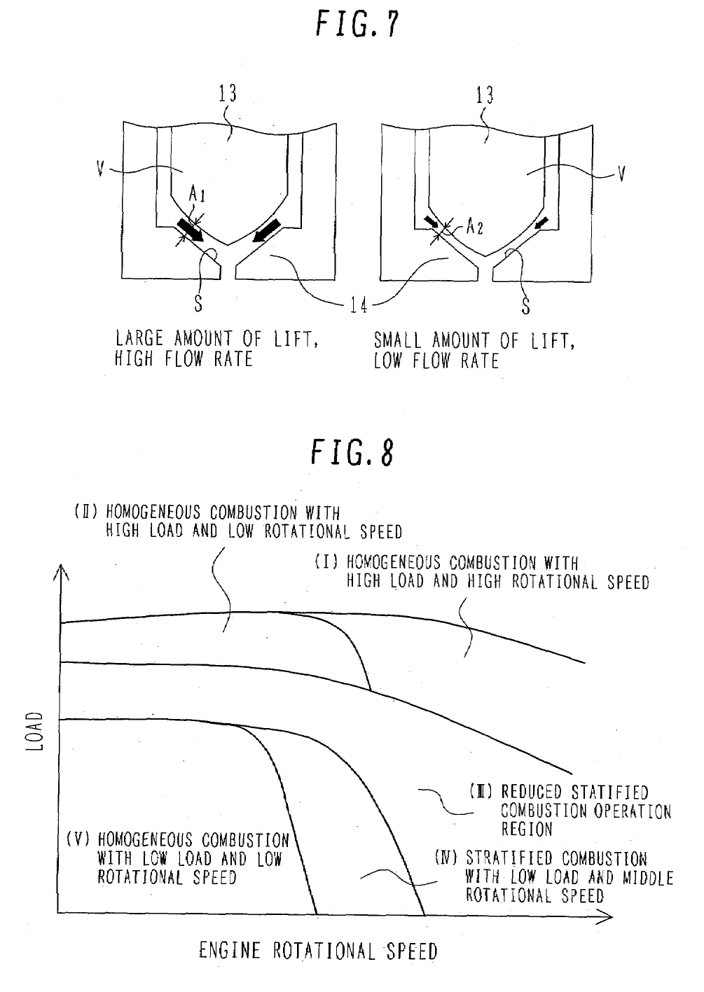

FIG. 8 shows examples of operation regions of a direct injection engine according to the present invention. FIG. 8 applies to a case where stratified combustion is actively performed for the purpose of improving the fuel efficiency. In order to improve the exhaust performance under such an operating condition, it is necessary to form an optimal fuel spray shape according to each operation region. The following explains as an example a case where the injector uses a giant magnetostrictive element as an actuator to form a swirl fuel spray. Referring to FIG. 8, the horizontal axis is assigned the rotational speed and the vertical axis the load. Reference numeral (i) denotes a homogeneous combustion operation region with high load and high rotational speed; (ii), a homogeneous combustion operation region with high load and low rotational speed; (iii), a reduced stratified combustion operation region; (iv), a stratified combustion operation region with low load and middle rotational speed; and (v), a homogeneous combustion operation region with low load and low rotational speed. In the operation region (i), it is necessary to inject much fuel in a short time, and the fuel is injected at one time in the suction stroke or during a time period from the exhaust stroke to the suction stroke.

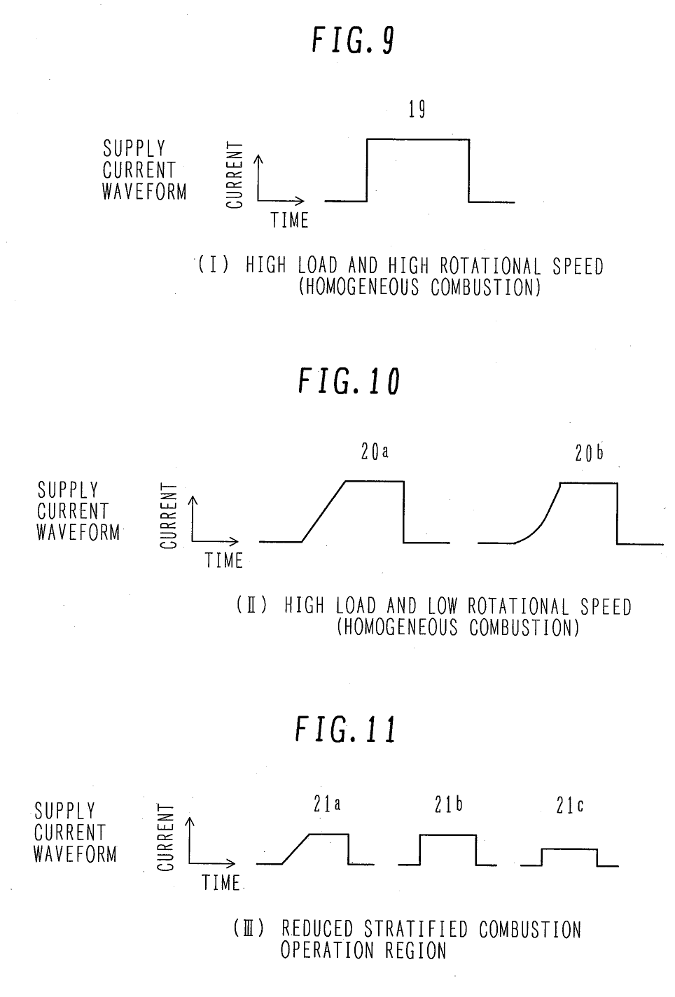

The operation region (i) represents an operating condition in which engine rotational speed is high and mixing effect by the piston is strong. Therefore the evaporation rate of the air-fuel mixture can be increased by widely distributing the fuel spray in the cylinder, making it possible to improve output power and fuel efficiency. For this reason, as a supply current applied from the drive circuit 6 to the injector 1, a supply current 19 having a steep rising slope and a large peak value as shown in FIG. 9 is selected. This makes it possible to increase the penetration and accordingly to increase the fuel spray spread, resulting in an improved evaporation rate of the fuel mixed with intake air.

In the operation region (ii), it is necessary to inject much fuel at one time in the suction stroke because of homogeneous combustion and high load. However, the engine operates under conditions of weak mixing effect by the piston because of low rotational speeds. Therefore, in the operation region (ii), a supply current 20a having a gentle rising slope and a large peak value as shown in FIG. 10 is selected. This makes it possible to decrease the penetration and accordingly to improve the evaporation rate of the fuel mixed with intake air while reducing the fuel adhesion to the cylinder wall surface and the piston top surface, thus preventing exhaust gas degradation. Further, in the case of degraded exhaust performance, it is also possible to decrease the penetration and accordingly to reduce the amount of fuel adhesion by use of a supply current 20b having a rising slope of a quadratic curve in comparison with the supply current 20a.

In the operation region (iii), improved fuel efficiency is realized by performing stratified combustion. In the operation region (iii), for example, fuel injection is split into two: one in the suction stroke and the other in the compression stroke. In this case, the spread of flame is ensured by forming a homogeneous lean premixed air-fuel mixture with suction stroke injection. Further, a dense air-fuel mixture for ignition is formed in the vicinity of the ignition plug with compression stroke injection immediately before ignition. The operation region (iii) represents an operation condition with rotational speeds ranging from high to low. Under the operating condition of low rotational speeds, the mixing effect by the piston is weak. Therefore a current waveform 21a having a gentle rising slope and a middle peak value as shown in FIG. 11 is selected for suction stroke injection. This decreases the penetration and accordingly reduces fuel adhesion to the wall surface. Further, by enlarging the fuel spray angle, it is possible to improve the evaporation rate of an air-fuel mixture and accordingly form a homogeneous lean premixed air-fuel mixture. Under the operating condition of high engine rotational speeds, the mixing effect by the piston is large; accordingly, a current waveform 21b having a steep rising slope and a middle peak value is selected for suction stroke injection. This increases the penetration to widely distribute the fuel spray in the cylinder and accordingly to improve the evaporation rate of the air-fuel mixture, thus forming a homogeneous lean premixed air-fuel mixture. On the other hand, the fuel spray injected in the compression stroke is used to form an air-fuel mixture for ignition. For this purpose, it is necessary to distribute a dense air-fuel mixture around the ignition plug. Further, because of a short time period from fuel injection to ignition and an increased internal cylinder pressure, the fuel does not easily reach the ignition plug. Therefore, a current waveform 21c having a steep rising slope and a small peak value is selected for compression stroke injection. Thus, by forming a fuel spray having a long penetration and a small fuel spray angle, a compact dense air-fuel mixture can be formed in the vicinity of the ignition plug.

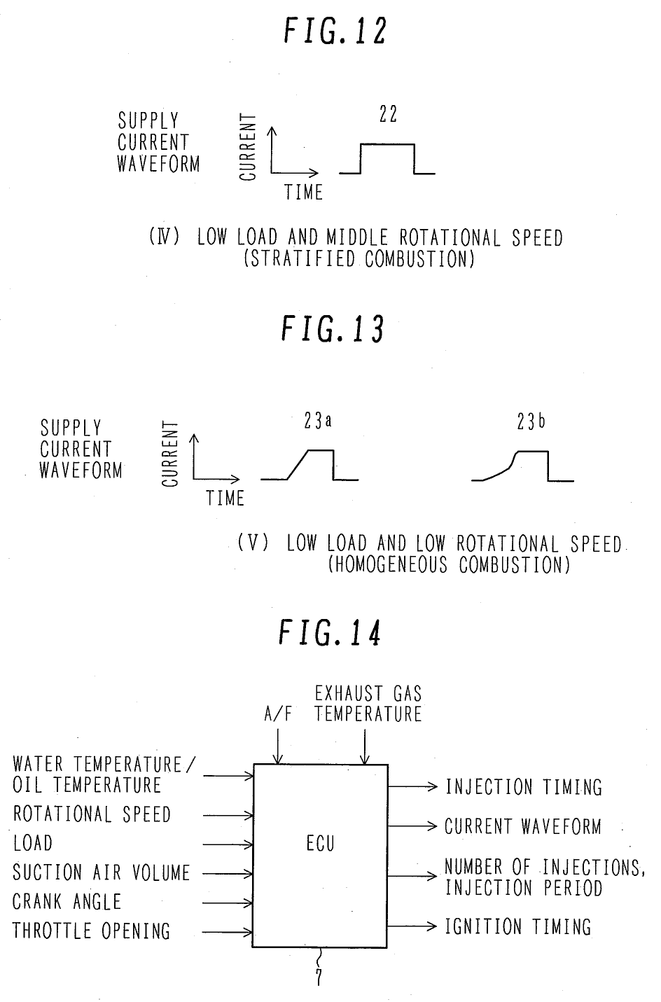

In the operation region (iv), improved combustion is realized by stratified combustion. However, because of a small load, fuel injection quantity is small making it difficult to split injection. Therefore, in the operation region (iv), fuel injection is performed once in the compression stroke, and a dense compact air-fuel mixture is distributed around the ignition plug to realize stratified combustion. Hence, a current waveform 22 having a steep rising slope and a middle peak value as shown in FIG. 12 is selected. This increases the penetration; accordingly, a dense compact air-fuel mixture can be distributed around the ignition plug even under conditions of high internal cylinder pressure.

In the operation region (v), fuel injection is performed once in the suction stroke in order to perform homogeneous combustion with low load and low rotational speed. In the operation region (v), in order to ensure the exhaust performance, a supply current 23a having a gentle rising slope and a middle peak value as shown in FIG. 13 is selected. Thus, by forming a fuel spray having a short penetration and a large fuel spray angle, it is possible to improve the evaporation rate of the fuel mixed with intake air while reducing fuel adhesion to the cylinder wall surface, thus preventing exhaust gas degradation. Further, in the case of degraded exhaust performance, it is also possible to decrease the penetration and accordingly to reduce the amount of fuel adhesion by use of a supply current 23b having a rising slope of a quadratic curve in comparison with the supply current 23a.

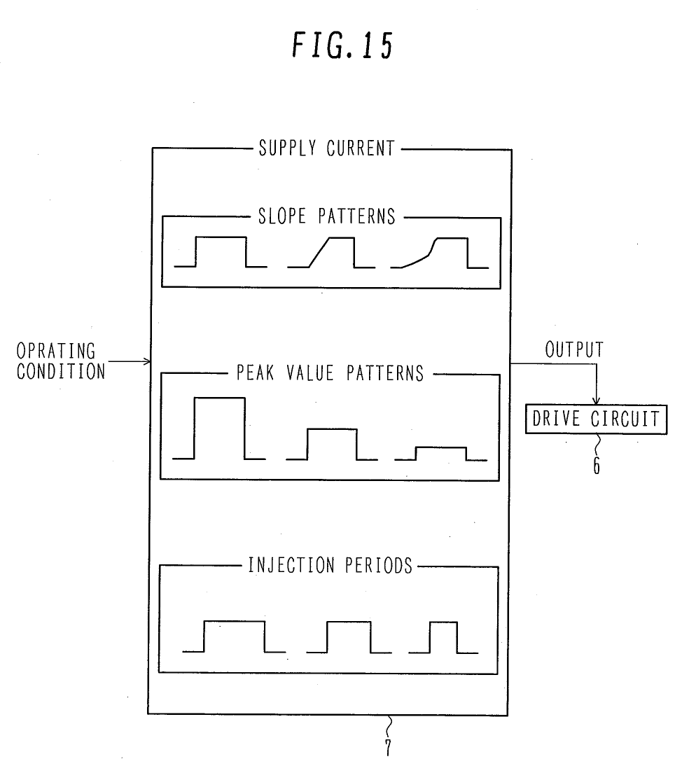

FIG. 14 shows examples of input/output signals of the ECU shown in FIG. 1. As shown in FIG. 14, the ECU 7 determines engine conditions from various sensors provided in the engine; selects an injection method according to the operation regions shown in FIG. 8; and outputs current waveform, injection timing, number of injections, and injection period to the injector drive circuit 6 and ignition timing to the ignition circuit 2a. FIG. 15 shows examples of current patterns stored in the ECU of FIG. 14.

As shown in FIG. 15, the ECU stores slope patterns and peak value patterns which are selected according to each operation region. Since the fuel injection quantity is calculated with an integral value of the current waveform supplied to the solenoid, the control of the final fuel injection quantity is adjusted by the injection period.

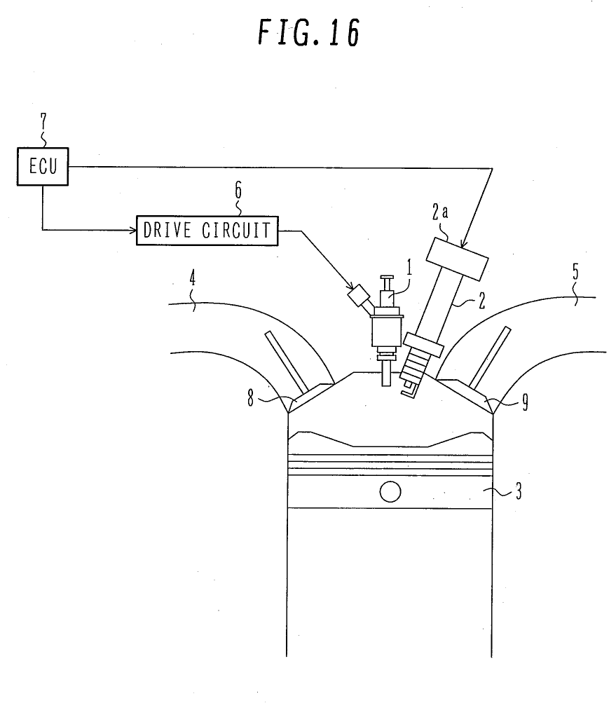

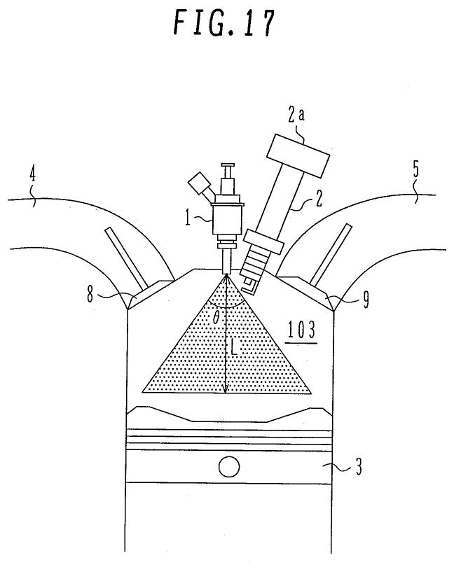

FIG. 16 shows an example of a second embodiment. FIG. 16 is a diagram showing an embodiment of a center injection engine comprising an injector arranged at the center of the combustion chamber and an ignition plug in the very vicinity of the injector.

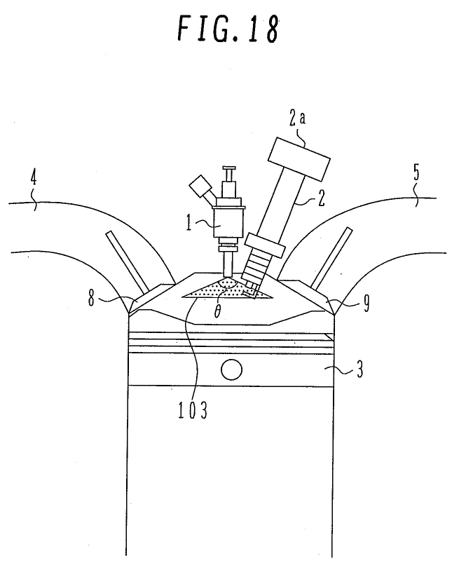

FIGS. 17 and 18 are examples of fuel spray shapes when the supply current applied to a swirl type injector is changed. FIG. 17 shows a case where the current pattern as shown in FIG. 5 is applied. Since the penetration can be controlled by the rising slope of the supply current applied to the solenoid, it is possible to reduce fuel adhesion to the piston top surface as shown in FIG. 17, thus improving exhaust gas. Further, since the fuel spray angle can be controlled by the peak value of the supply current, it is possible to reduce fuel adhesion to the cylinder wall surface. FIG. 18 shows a case where fuel injection is performed in the compression stroke to realize stratified combustion. In this case, the fuel spray angle can be increased by increasing the peak value of the supply current. Accordingly, a dense air-fuel mixture can be formed in the vicinity of the ignition plug, enabling stratified combustion in a more stable manner.

Based on a physical phenomenon that displacement characteristics of a giant magnetostrictive element are closely related to a change of a current applied to a solenoid for magnetic field generation which displaces the giant magnetostrictive element, the present embodiment makes it possible to control the penetration, spread angle, and density of the fuel spray injected from an fuel injection hole on a downstream side of a sheet with simple components (a valve and the sheet member) by controlling the valve opening speed or stroke of the injector.

As a result, it has become possible to accurately fine-adjust the shape of the fuel spray injected by the giant magnetostrictive injector according to operating conditions, resulting in a favorable exhaust gas emission and improved fuel efficiency.

The present invention is applicable to a hole nozzle type injector, a plate nozzle type injector, a multi-hole type injector, etc., in addition to a solid fuel spray type injector and an injector with a swirler explained in the embodiments.

Further, the present invention is applicable to piezoelectric element type and magnetostrictive element type injectors and also to a solenoid-driven injector if the response speed is increased by an improved magnetic circuit.

Further, as an internal-combustion engine, the present invention is not influenced by the attachment position of the injector. Therefore, the present invention can be applied to a direct fuel injection engine wherein an injector is provided on a side surface of the cylinder block and the cylinder head and also to a direct fuel injection engine of a center injection type wherein an injector is provided at the top of the cylinder head. Further, the present invention can also be applied to an injector of an internal-combustion engine which injects fuel to a suction port.

1. A fuel injector of an internal-combustion engine, comprising:
at least one fuel injection hole;
a sheet surface located on an upstream side of the fuel injection hole;
a valve which controls opening and closing of a fuel passage leading to the fuel injection hole by the valve touching and separating from the sheet surface; and
an electromagnetic drive unit which operates the valve;
wherein the valve is maintained to any desired opening position between a fully-opened position and a fully-closed position at which the valve comes in contact with the sheet surface depending on the magnitude of the power supplied to the electromagnetic drive unit.

2. The injector of an internal-combustion engine according to claim 1, wherein:
the electromagnetic drive unit comprises:
an electromagnetic solenoid;
a magnetostrictive element whose amount of expansion/contraction varies with electromagnetic force generated by the electromagnetic solenoid; and
a displacement transmission mechanism that transmits the displacement of expansion/contraction of the magnetostrictive element to the valve.

3. The injector of an internal-combustion engine according to claim 2, wherein:
the magnetostrictive element is composed of at least one cylindrical giant magnetostrictive element.

4. The method of controlling an injector of an internal combustion engine according to claim 1, wherein conditions of power supply to the electromagnetic drive unit or the electromagnetic solenoid forming the electromagnetic drive unit are controlled according to engine operating conditions, thereby controlling the valve open/closed condition of the injector so as to control the fuel injection quantity;
wherein a time period of power distribution to the electromagnetic drive unit or the electromagnetic solenoid forming the electromagnetic drive unit is controlled to control the fuel injection quantity; and
wherein at least either one of the rising slope and the peak value of the current is controlled to control at least either one of the penetration, the fuel spray angle, and the fuel spray density of injected fuel.

5. The method of controlling an injector of an internal combustion engine according to claim 1, wherein:
conditions of power supply to the electromagnetic drive unit or the electromagnetic solenoid forming the electromagnetic drive unit are controlled according to engine operating conditions, thereby controlling at least either one of the magnitude and the change rate (in relation to time) of a cross-sectional area of a fuel passage between the valve and the sheet surface of the injector.

6. The method of controlling an injector of an internal combustion engine according to claim 2, wherein either the magnitude or the change rate (in relation to time) of a current supplied to the magnetostrictive element or the electromagnetic solenoid of a giant magnetostrictive element is controlled according to engine operating conditions; and
wherein either the expansion/contraction amount or the change rate (in relation to time) of the expansion/contraction amount of the magnetostrictive element or the giant magnetostrictive element is controlled, thereby controlling the lift amount of the valve.

7. A control circuit unit used to perform the method of controlling an injector of an internal combustion engine according to claim 1, wherein:
as a drive signal of the injector, an output terminal outputs a signal which indicates a time period from a rise to a fall of the current and indicates at least either one of the change rate of a current value in relation to a time period since the current rises until it reaches a peak value and the magnitude of a final current value.

8. A fuel injection system of a direct fuel injection engine which performs variable control of fuel spray shapes, the fuel injection system comprising:
an injector using a giant magnetostrictive element as an actuator;
a solenoid for magnetic field generation which displaces the giant magnetostrictive element; and
control means for controlling the change rate of a supply current applied to the solenoid.

9. A fuel injection system of a direct fuel injection engine which performs variable control of fuel spray shapes, the fuel injection system comprising:
an injector using a giant magnetostrictive element as an actuator;
a solenoid for magnetic field generation which displaces the giant magnetostrictive element; and
control means for controlling a peak value of a supply current applied to the solenoid.

10. The fuel injection system of a direct injection engine according to claim 8, wherein: the control means includes:
storage means for storing at least either one of the change rate and the peak value of the supply current applied to the solenoid as a plurality of patterns based on engine operating conditions, and
selection means for selecting a pattern out of the patterns according to engine operating conditions.

11. The fuel injection system of a direct injection engine according to claim 8, wherein:
a lifting speed is controlled by the change rate of a supply current applied to the solenoid, thereby controlling the penetration of a fuel spray injected.

12. The fuel injection system of a direct injection engine according to claim 9, wherein:
the amount of a lift is controlled by the peak value of the supply current applied to the solenoid, thereby controlling the fuel spray density or the fuel spray angle of a fuel spray injected.

13. The method of controlling an injector of an internal combustion engine according to any one of claim 2, wherein conditions of power supply to the electromagnetic drive unit or the electromagnetic solenoid forming the electromagnetic drive unit are controlled according to engine operating conditions, thereby controlling the valve open/closed condition of the injector so as to control the fuel injection quantity;
wherein a time period of power distribution to the electromagnetic drive unit or the electromagnetic solenoid forming the electromagnetic drive unit is controlled to control the fuel injection quantity; and
wherein at least either one of the rising slope and the peak value of the current is controlled to control at least either one of the penetration, the fuel spray angle, and the fuel spray density of injected fuel.

14. The method of controlling an injector of an internal combustion engine according to any one of claim 3, wherein conditions of power supply to the electromagnetic drive unit or the electromagnetic solenoid forming the electromagnetic drive unit are controlled according to engine operating conditions, thereby controlling the valve open/closed condition of the injector so as to control the fuel injection quantity;
wherein a time period of power distribution to the electromagnetic drive unit or the electromagnetic solenoid forming the electromagnetic drive unit is controlled to control the fuel injection quantity; and
wherein at least either one of the rising slope and the peak value of the current is controlled to control at least either one of the penetration, the fuel spray angle, and the fuel spray density of injected fuel.

15. The method of controlling an injector of an internal combustion engine according to any one of claim 2, wherein: conditions of power supply to the electromagnetic drive unit or the electromagnetic solenoid forming the electromagnetic drive unit are controlled according to engine operating conditions, thereby controlling at least either one of the magnitude and the change rate (in relation to time) of a cross-sectional area of a fuel passage between the valve and the sheet surface of the injector.

16. The method of controlling an injector of an internal combustion engine according to any one of claim 3, wherein: conditions of power supply to the electromagnetic drive unit or the electromagnetic solenoid forming the electromagnetic drive unit are controlled according to engine operating conditions, thereby controlling at least either one of the magnitude and the change rate (in relation to time) of a cross-sectional area of a fuel passage between the valve and the sheet surface of the injector.

17. The method of controlling an injector of an internal combustion engine according to claim 3, wherein either the magnitude or the change rate (in relation to time) of a current supplied to the magnetostrictive element or the electromagnetic solenoid of a giant magnetostrictive element is controlled according to engine operating conditions; and
wherein either the expansion/contraction amount or the change rate (in relation to time) of the expansion/contraction amount of the magnetostrictive element or the giant magnetostrictive element is controlled, thereby controlling the lift amount of the valve.

18. The fuel injection system of a direct injection engine according to claim 9, wherein: the control means includes: storage means for storing at least either one of the change rate and the peak value of the supply current applied to the solenoid as a plurality of patterns based on engine operating conditions, and
selection means for selecting a pattern out of the patterns according to engine operating conditions.
